(19) United States
(12) Patent Application Publication
(10) Pub. No.: US 2026/0142110 A1
(43) Pub. Date: May 21, 2026

(54) RELAY WITH SHIELDING SHELL

(71) Applicant: Xiamen Hongfa Electric Power Controls Co., Ltd., Xiamen, Fujian (CN)

(72) Inventors: Zhigang WEN, Xiamen, Fujian (CN); Shuming ZHONG, Xiamen, Fujian (CN); Wenguang DAI, Xiamen, Fujian (CN); Fangneng LI, Xiamen, Fujian (CN)

(21) Appl. No.: 19/120,972

(22) PCT Filed: Sep. 7, 2023
(86) PCT No.: PCT/CN2023/117540

§ 371 Date: Apr. 14, 2025

(30) Foreign Application Priority Data
Oct. 13, 2022 (CN) 202211251896.1

(51) Int. Cl. H01H 50/10; H01H 50/02; H01H 50/12

(52) U.S. Cl. CPC H01H 50/10; H01H 50/021; H01H 50/12

(57) ABSTRACT

A relay with a shielding shell includes a housing and a contact structure within the housing. The shielding shell is connected to the housing. The shielding shell includes a bottom plate capable of being in contact with a bottom of an electric meter to be installed. The bottom plate of the shielding shell is in contact with a bottom surface of the housing. A heat dissipation flank laterally extending outwards is formed at least on the bottom plate of the shielding shell, and an outward extension range of the heat dissipation flank relative to the bottom plate is configured to at least cover an orthographic projection area of the contact structure on the bottom surface of the housing.

### CROSS-REFERENCE

The present disclosure is a national stage of International PCT Application No. PCT/CN 2023/117540, filed on Sep. 7, 2023, which claims priority to Chinese Patent Application No. 202211251896.1, filed on Oct. 13, 2022. The content of forgoing applications is incorporated herein by reference in its entirety.

### TECHNICAL FIELD

The present disclosure generally relates to the technical field of relays and, more particularly, to a relay with a shielding shell.

### BACKGROUND

Chinese patent document CN209216895U (Application Date: December 14, 2018) discloses a multi-circuit magnetic latching relay, including a seat made of insulating material. The seat is provided with a magnetic latching mechanism, a plurality of sets of movable and static contacts, and an even number of conductive terminals. The seat is provided with a pushing assembly, and a cover is fixedly connected to the seat. All conductive terminals are embedded into the seat along a same direction, and every two conductive terminals are connected or disconnected through one set of movable and static contacts. A U-shaped shielding cover is clamped on an outer end face of the cover and an outer end face of the seat; the outer end face of the cover and the outer end face of the seat are each provided with a positioning column; two arms of the U-shaped shielding cover are each provided with a positioning hole; two positioning columns are correspondingly fitted with two positioning holes; and the U-shaped shielding cover covers a magnetic circuit of the magnetic latching mechanism. However, in this technical solution, the U-shaped shielding cover mainly plays an anti-magnetic role, and a coverage range of the U-shaped shielding cover obviously does not correspond to a contact structure inside the multi-circuit magnetic latching relay, i.e., the contact structure inside the multi-circuit magnetic latching relay is outside the coverage range of the U-shaped shielding cover; when the magnetic latching relay is installed within an electric meter, a bottom of the U-shaped shielding cover directly contacts a bottom plate of the electric meter, which results in a narrow heat dissipation space between the multi-circuit magnetic latching relay and the bottom plate of the electric meter, easily leads to poor heat dissipation of the magnetic latching relay, and affecting the safety and service life of the magnetic latching relay.

### SUMMARY

A relay with a shielding shell includes a housing and a contact structure within the housing. The shielding shell is connected to the housing. The shielding shell includes a bottom plate capable of being in contact with a bottom of an electric meter to be installed. The bottom plate of the shielding shell is in contact with a bottom surface of the housing. A heat dissipation flank laterally extending outwards is formed at least on the bottom plate of the shielding shell, and an outward extension range of the heat dissipation flank relative to the bottom plate is configured to at least cover an orthographic projection area of the contact structure on the bottom surface of the housing.

According to some embodiments of the present disclosure, one heat dissipation flank is formed at each of left and right sides of the bottom plate, and two heat dissipation flanks correspond to two sets of contact structures within the housing.

According to some embodiments of the present disclosure, the shielding shell has a generally U-shaped structure, and the shielding shell further includes a top plate in contact with a top surface of the housing and a side plate that connects the bottom plate with the top plate and is in contact with a rear side of the housing.

According to some embodiments of the present disclosure, a positioning structure for positioning the top plate of the shielding shell is provided on the top surface of the housing, and the shielding shell is fitted onto the housing from the rear side of the housing and is fixed by positioning fitting between the top plate and the positioning structure on the top surface of the housing.

According to some embodiments of the present disclosure, the relay with the shielding shell is a magnetic latching relay.

According to some embodiments of the present disclosure, a width dimension of the bottom plate of the shielding shell is defined as D, and a width dimension of the heat dissipation flank at an edge of the bottom plate is configured to be approximately equal to the width dimension D of the bottom plate.

According to some embodiments of the present disclosure, a positioning lug is formed on the heat dissipation flank and protrudes from a rear side of the housing.

According to some embodiments of the present disclosure, a positioning protrusion is formed at a front side of the housing and configured to position and fit with the electric meter to be installed.

According to some embodiments of the present disclosure, a thermally conductive adhesive for thermal conductivity is provided on an inner surface and/or an outer surface of the bottom plate of the shielding shell.

### BRIEF DESCRIPTION OF THE DRAWINGS

The above and other features and advantages of the present disclosure will become more apparent by describing in detail exemplary embodiments with reference to the accompanying drawings.

FIG. 1 is a perspective schematic view of an embodiment of a relay with a shielding shell according to the present disclosure.

FIG. 2 is a top view of FIG. 1.

FIG. 3 is a bottom view of FIG. 1.

FIG. 4 is a right view of FIG. 1.

### REFERENCE NUMERALS

1. housing; 2. shielding shell; 11. positioning protrusion; 21. bottom plate; 22. top plate; 23. side plate; 211. heat dissipation flank; 212. positioning lug.

### DETAILED DESCRIPTION

Exemplary embodiments will be now described more fully with reference to the accompanying drawings. However, the exemplary embodiments may be embodied in a variety of forms and should not be construed as being limited to the embodiments set forth herein. Although relative terms such as “above” and “under” are used herein to describe the relationship of one component relative to another component, such terms are used herein only for the sake of convenience, for example, in the directions shown in the figures. It may be understood that if the referenced device is inversed upside down, a component described as “above” will become a component described as “under”. Other relative terms such as “top” and “bottom” also have similar meanings. When a structure is described as “above” another structure, it probably means that the structure is integrally formed on another structure, or the structure is “directly” disposed on another structure, or the structure is “indirectly” disposed on another structure through an additional structure.

Words “one”, “a/an”, “the” and “said” are used herein to indicate the presence of one or more elements/component parts/and others. Terms “including” and “having” have an inclusive meaning which means that there may be additional elements/component parts/and others in addition to the listed elements/component parts/and others. Terms such as “first” and “second” are used herein only as markers and do not limit the number of objects modified after them.

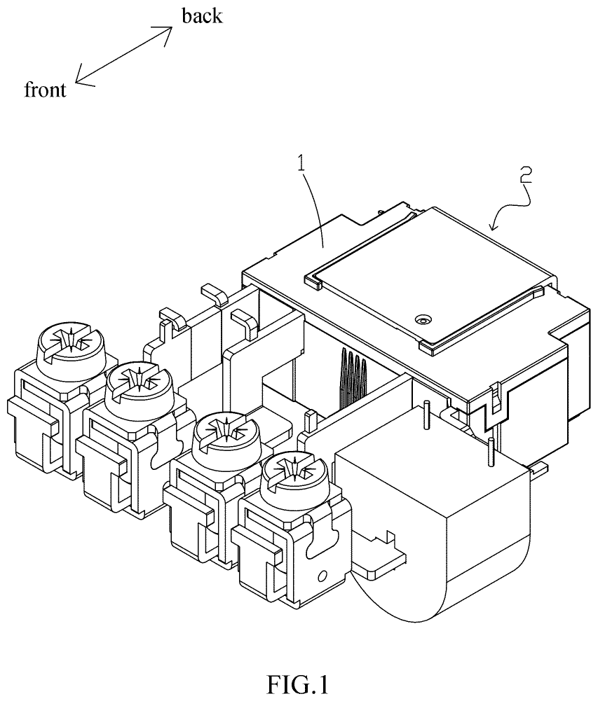

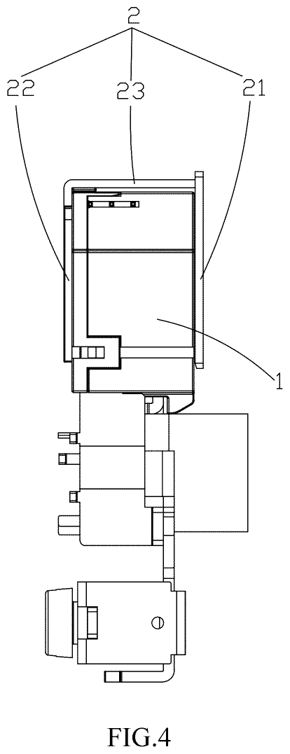

Referring to FIGS. 1 to 4, an embodiment of the present disclosure provides a relay with a shielding shell, and the relay includes a housing 1 and a contact structure within the housing 1. The housing 1 is connected with a shielding shell 2; a side of the shielding shell 2 in contact with a bottom of an electric meter to be installed (not shown in the figures) is defined as a bottom plate 21 of the shielding shell 2; and the bottom plate 21 of the shielding shell 2 is in contact with a bottom surface of the housing 1. A heat dissipation flank 211 laterally extending outwards is formed at least on the bottom plate 21 of the shielding shell 2, an outward extension range of the heat dissipation flank 211 relative to the bottom plate 21 is configured to at least cover an orthographic projection area of the contact structure on the bottom surface of the housing 1.

It may be understood that, in this embodiment, the heat dissipation flank 211 laterally extending outwards is formed on the bottom plate 21 of the shielding shell 2, and the outward extension range of the heat dissipation flank 211 covers a projection of the contact structure within the housing 1 on the bottom surface of the housing 1, so that when the relay is installed within the electric meter, the bottom plate 21 of the shielding shell 2 is directly in contact with a bottom of the electric meter. Although the heat dissipation flank 211 added to the shielding shell 2 does not enlarge a heat dissipation space between a bottom of the relay and the bottom of the electric meter, the heat dissipation flank 211 corresponding to the contact structure within the housing 1 can effectively improve the heat conduction efficiency between a bottom of the housing 1 and the bottom of the electric meter due to the direct contact between the bottom plate 21 of the shielding shell 2 and the bottom of the electric meter. The original narrow space for heat dissipation has been replaced with direct conduction to the bottom of the electric meter for heat dissipation through the heat dissipation flank 211, which can effectively improve the heat dissipation efficiency of the relay without changing an original anti-magnetic effect of the shielding shell 2, and hence ensure the safety and service life of the relay.

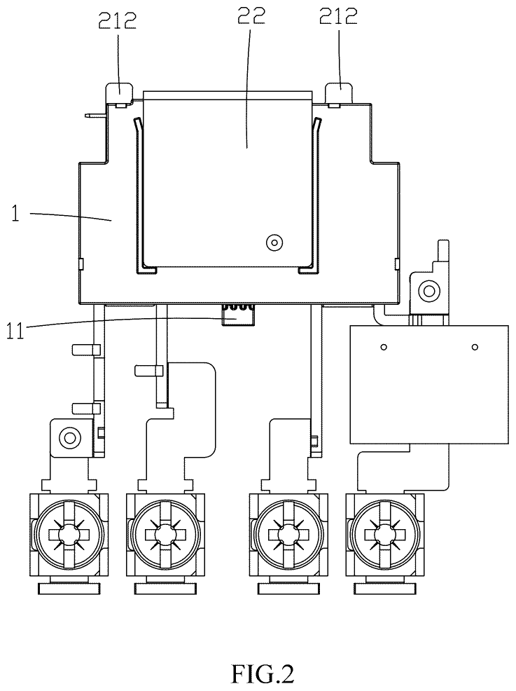

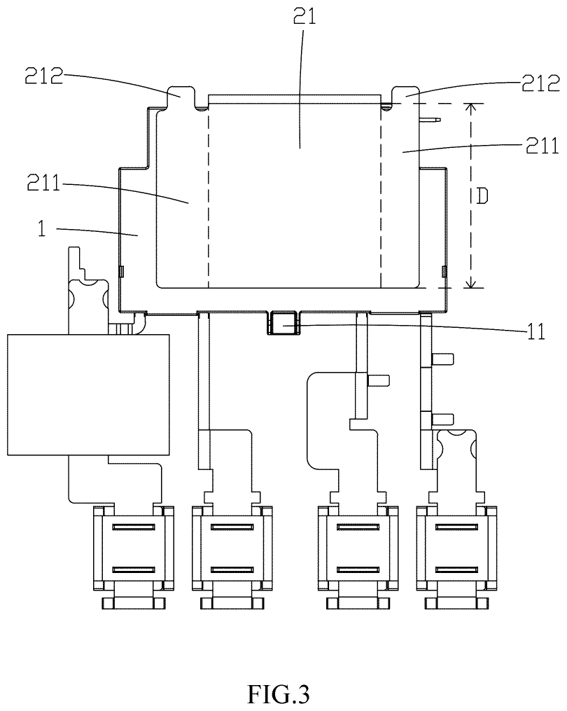

Referring to FIGS. 2 and 3, in one preferred embodiment, one heat dissipation flank 211 is formed at each of left and right sides of the bottom plate 21, and two heat dissipation flanks 211 correspond to two sets of contact structures within the housing 1. However, those skilled in the art should understand that, in other embodiments, if a plurality of sets of contact structures are provided within the housing 1 of the relay, the outward extension range of the heat dissipation flanks 211 is configured to cover the orthographic projection area of all contact structures on the bottom of the housing 1, so that heat radiated directly from the contact structures to the corresponding area at the bottom of the housing 1 may be efficiently conducted directly to the bottom of the meter through the heat dissipation flanks 211, thereby improving the heat dissipation effect.

Referring to FIGS. 1 to 4, in one preferred embodiment, the shielding shell 2 has a generally U-shaped structure, and the shielding shell 2 includes a bottom plate 21 in contact with the bottom surface of the housing 1, a top plate 22 in contact with a top surface of the housing 1, and a side plate 23 that connects the bottom plate 21 with the top plate 22 and is in contact with a rear side of the housing 1. A positioning structure for positioning the top plate 22 of the shielding shell 2 is provided on the top surface of the housing 1. The shielding shell 2 is fitted onto the housing 1 from the rear side of the housing 1 and is fixed by the positioning fitting between the top plate 22 and the positioning structure on the top surface of the housing 1.

It may be understood that, in this embodiment, several positioning ribs may be provided at the top of the housing 1, and the positioning ribs cooperate with each other to enclose a positioning slot structure, so that the top plate 22 of the shielding shell 2 may be adaptively inserted and positioned in the corresponding positioning slot structure. In addition, a positioning convex point may be provided in the positioning slot structure, and a positioning hole may be provided in the top plate 22 of the shielding shell 2 and fitted with the positioning convex point at the top of the housing 1, so that when the top plate 22 is fully inserted into in the positioning slot structure at the top of the housing 1, the positioning fitting between the positioning convex point and the positioning hole may play a role in preventing the top plate 22 from retreating, so as to make the top plate 22 more stably connected to the housing 1 and ensure the stability and tightness of the connection between the shielding shell 2 and the housing 1. However, those skilled in the art should understand that, in other embodiments, the shielding shell 2 may also be detachably connected to the housing 1 by other means such as a snap connection, which is not limited to the specific implementation disclosed in this embodiment.

Referring to FIGS. 1 to 4, in one preferred embodiment, the relay with the shielding shell is a magnetic latching relay.

Referring to FIGS. 1 and 3, in one preferred embodiment, a width dimension of the bottom plate 21 of the shielding shell 2 is defined as D, and a width dimension of the heat dissipation flank 211 at an edge of the bottom plate 21 is designed to be approximately equal to the width dimension D of the bottom plate 21. In this embodiment, preferably, the heat dissipation flank 211 has an elongate structure and is integrally formed with the bottom plate 21; the width dimension of the heat dissipation flank 211 is identical equal to or approximately equal to the width dimension D of the bottom plate 21. However, those skilled in the art should understand that, in other embodiments, the shape of the heat dissipation flank 211 is not limited to the specific implementation disclosed in this embodiment, and may also be of other structures, as long as the outward extension range of the heat dissipation flank 211 can at least cover the orthographic projection area of the contact structure on the bottom surface of the housing 1.

Referring to FIGS. 2 and 3, in one preferred embodiment, a positioning lug 212 is formed on the heat dissipation flank 211 and protrudes from the rear side of the housing 1. A positioning protrusion 11 is formed at a front side of housing 1 and configured to position and fit with the electric meter to be installed. It may be understood that, in this embodiment, the positioning lug 212 on the shielding shell 2 and the positioning protrusion 11 on the housing 1 fit with corresponding positioning structures within the electric meter, to allow the relay to be more stably connected to the electric meter, which is conducive to the closer fit between the relay and a built-in heat sink (not shown in the figures) of the electric meter, and improves the heat dissipation effect. However, those skilled in the art should understand that, in other embodiments, the positioning lug 212 on the heat dissipation flank 211 and the positioning protrusion 11 on the housing 1 are not limited to the specific implementation disclosed in this embodiment in terms of their positions and shape structures, as long as the relay may be more stably connected to the electric meter to facilitate a better fit between the relay and the built-in heat sink of the electric meter in order to dissipate heat.

In one preferred embodiment, a thermally conductive adhesive for thermal conductivity is preferably provided on an inner surface (a side in contact with the bottom surface of the housing 1 of the relay) and/or an outer surface (a side in contact with the bottom of the electric meter) of the bottom plate 21 of the shielding shell 2. The thermally conductive adhesive may be made of heat dissipating silicone or thermally conductive silicone sheet to improve the efficiency of heat dissipation between the bottom of the relay and the bottom of the meter.

In the relay with the shielding shell according to the present disclosure, the heat dissipation flank laterally extending outwards is formed on the bottom plate of the shielding shell, and the outward extension range of the heat dissipation flank covers a projection of the contact structure within the housing on the bottom surface of the housing, so that when the relay is installed within the electric meter, the bottom plate of the shielding shell is directly in contact with a bottom of the electric meter. Although the heat dissipation flank added to the shielding shell does not enlarge a heat dissipation space between a bottom of the relay and the bottom of the electric meter, the heat dissipation flank corresponding to the contact structure within the housing can effectively improve the heat conduction efficiency between the bottom of the housing and the bottom of the electric meter due to the direct contact between the bottom plate of the shielding shell and the bottom of the electric meter. The original narrow space for heat dissipation has been replaced with direct conduction to the bottom of the electric meter for heat dissipation through the heat dissipation flank, which can effectively improve the heat dissipation efficiency of the relay without changing an original anti-magnetic effect of the shielding shell, and hence ensure the safety and service life of the relay.

It should be understood that the application of the present disclosure is not limited to the detailed structure and arrangement of components provided in this specification. The present disclosure may have other embodiments, and may be implemented and carried out in various ways. The aforementioned variations and modifications fall within the scope of the present disclosure. It should be understood that the present disclosure revealed and defined in this specification may extend to all alternative combinations of two or more individual features that are apparent or mentioned in the text and/or drawings. All of the different combinations form various alternative aspects of the present disclosure. Embodiments described in this specification illustrate the best modes known for carrying out the present disclosure, and will allow those skilled in the art to utilize the present disclosure.

1. A relay with a shielding shell, comprising a housing and a contact structure within the housing a shielding shell being connected to the housing,
wherein the shielding shell comprises a bottom plate capable of being in contact with a bottom of an electric meter to be installed; the bottom plate of the shielding shell is in contact with a bottom surface of the housing a heat dissipation flank laterally extending outwards is formed at least on the bottom plate of the shielding shell and an outward extension range of the heat dissipation flank relative to the bottom plate is configured to at least cover an orthographic projection area of the contact structure on the bottom surface of the housing.

2. The relay with the shielding shell according to claim 1, wherein one heat dissipation flank is formed at each of left and right sides of the bottom plate and two heat dissipation flanks correspond to two sets of contact structures within the housing.

3. The relay with the shielding shell according to claim 1, wherein the shielding shell has a generally U-shaped structure, and the shielding shell further comprises a top plate in contact with a top surface of the housing and a side plate that connects the bottom plate with the top plate and is in contact with a rear side of the housing.

4. The relay with the shielding shell according to claim 3, wherein a positioning structure for positioning the top plate of the shielding shell is provided on the top surface of the housing and the shielding shell is fitted onto the housing from the rear side of the housing and is fixed by positioning fitting between the top plate and the positioning structure on the top surface of the housing.

5. The relay with the shielding shell according to claim 1, wherein the relay with the shielding shell is a magnetic latching relay.

6. The relay with the shielding shell according to claim 1, wherein a width dimension of the bottom plate of the shielding shell is defined as D, and a width dimension of the heat dissipation flank at an edge of the bottom plate is configured to be approximately equal to the width dimension D of the bottom plate.

7. The relay with the shielding shell according to claim 1, wherein a positioning lug is formed on the heat dissipation flank and protrudes from a rear side of the housing.

8. The relay with the shielding shell according to claim 1, wherein a positioning protrusion is formed at a front side of the housing and configured to position and fit with the electric meter to be installed.

9. The relay with the shielding shell according to claim 1, wherein a thermally conductive adhesive for thermal conductivity is provided on an inner surface and/or an outer surface of the bottom plate of the shielding shell.

10. The relay with the shielding shell according to claim 2, wherein a thermally conductive adhesive for thermal conductivity is provided on an inner surface and/or an outer surface of the bottom plate of the shielding shell.

11. The relay with the shielding shell according to claim 3, wherein a thermally conductive adhesive for thermal conductivity is provided on an inner surface and/or an outer surface of the bottom plate of the shielding shell.

12. The relay with the shielding shell according to claim 4, wherein a thermally conductive adhesive for thermal conductivity is provided on an inner surface and/or an outer surface of the bottom plate of the shielding shell.

13. The relay with the shielding shell according to claim 5, wherein a thermally conductive adhesive for thermal conductivity is provided on an inner surface and/or an outer surface of the bottom plate of the shielding shell.

14. The relay with the shielding shell according to claim 6, wherein a thermally conductive adhesive for thermal conductivity is provided on an inner surface and/or an outer surface of the bottom plate of the shielding shell.

15. The relay with the shielding shell according to claim 7, wherein a thermally conductive adhesive for thermal conductivity is provided on an inner surface and/or an outer surface of the bottom plate of the shielding shell.

16. The relay with the shielding shell according to claim 8, wherein a thermally conductive adhesive for thermal conductivity is provided on an inner surface and/or an outer surface of the bottom plate of the shielding shell.

17. The relay with the shielding shell according to claim 2, wherein a positioning lug is formed on the heat dissipation flank and protrudes from a rear side of the housing; a positioning protrusion is formed at a front side of the housing and configured to position and fit with the electric meter to be installed.

18. The relay with the shielding shell according to claim 3, wherein a positioning lug is formed on the heat dissipation flank and protrudes from a rear side of the housing; a positioning protrusion is formed at a front side of the housing and configured to position and fit with the electric meter to be installed.

19. The relay with the shielding shell according to claim 4, wherein a positioning lug is formed on the heat dissipation flank and protrudes from a rear side of the housing; a positioning protrusion is formed at a front side of the housing and configured to position and fit with the electric meter to be installed.

20. The relay with the shielding shell according to claim 6, wherein a positioning lug is formed on the heat dissipation flank and protrudes from a rear side of the housing; a positioning protrusion is formed at a front side of the housing and configured to position and fit with the electric meter to be installed.
